(19) United States
(12) Patent Application Publication
(10) Pub. No.: US 2026/0328104 A1
(43) Pub. Date: Oct. 22, 2026

(54) COMPOSITE VARIABLE STATOR VANE IN TURBINE ENGINES

(71) Applicant: General Electric Company, Evendale, OH (US)

(72) Inventors: Ming Xie, Dayton, OH (US); Nicholas J. Kray, Mason, OH (US); Douglas Lorrimer Armstrong, Needham, MA (US)

(21) Appl. No.: 19/181,528

(22) Filed: Apr. 17, 2025

(51) Int. Cl. F01D 9/02; F01D 5/14

(52) U.S. Cl. CPC F01D 9/02; F01D 5/147; F05D 2240/12; F05D 2250/11; F05D 2250/13; F05D 2300/522; F05D 2300/6034

(57) ABSTRACT

A variable stator vane includes a metallic end defining a longitudinal axis of the variable stator vane, the metallic end being configured to add rigidity and to provide wear resistance to the variable stator vane, an intermediate portion coupled to the metallic end, and an airfoil portion coupled to the intermediate portion, the airfoil portion being made of a composite material. The metallic end, the intermediate portion, and the airfoil portion are rotatable around the longitudinal axis of the variable stator vane.

### TECHNICAL FIELD

The present disclosure relates generally to composite variable stator vanes in turbine engines.

### BACKGROUND

Gas turbine engines generally include a fan and a turbo-engine arranged in flow communication with one another, with the turbo-engine disposed downstream of the fan in a direction of flow through the gas turbine engine. The turbo-engine generally includes, in serial flow order, a compressor section, a combustion section, a turbine section, and an exhaust section. With multi-shaft gas turbine engines, the compressor section can include a high pressure (HP) compressor disposed downstream of a low pressure (LP) compressor, and the turbine section can similarly include a low pressure (LP) turbine disposed downstream of a high pressure (HP) turbine. The combustion section includes a combustor that generates combustion gases discharged into the turbine section. With such a configuration, the HP compressor is coupled with the HP turbine via a high pressure (HP) shaft, and the LP compressor is coupled with the LP turbine via a low pressure (LP) shaft. The LP compressor, the HP compressor, the LP turbine, and the HP turbine may, for example include variable stator vanes (VSVs).

### BRIEF DESCRIPTION OF THE DRAWINGS

Features and advantages will be apparent from the following, more particular, description of various embodiments, as illustrated in the accompanying drawings, wherein like reference numbers generally indicate identical, functionally similar, or structurally similar elements, or both.

FIG. 1 is a schematic, cross-sectional view of a turbine engine, taken along a longitudinal centerline axis of the turbine engine, according to an embodiment of the present disclosure.

FIG. 2 is a schematic, perspective view of a variable stator vane (VSV), according to an embodiment of the present disclosure.

FIG. 3 is a schematic, cross-sectional view of a VSV, according to another embodiment of the present disclosure.

FIG. 4 is a schematic, cross-sectional view of the VSV shown in FIG. 3 supported at one end, according to another embodiment of the present disclosure.

FIG. 5A is a schematic, cross-sectional view of a portion of the VSV shown in FIG. 3 showing a scarf joint between a first intermediate portion and an airfoil portion, according to an embodiment of the present disclosure.

FIG. 5B is a schematic, cross-sectional view of a portion of the VSV shown in FIG. 3 showing a double scarf joint between the first intermediate portion and the airfoil portion, according to an embodiment of the present disclosure.

FIG. 5C is a schematic, cross-sectional view of a portion of the VSV shown in FIG. 3 showing a dovetail joint between the first intermediate portion and the airfoil portion, according to an embodiment of the present disclosure.

FIG. 5D is a schematic, cross-sectional view of a portion of the VSV shown in FIG. 3 showing a non-composite material (e.g., foam material) insert incorporated within layers of a composite material of the airfoil portion, according to an embodiment of the present disclosure.

FIG. 6 is a schematic, transverse, cross-sectional view of the airfoil portion 306 taken at line 6-6 shown in FIG. 3, according to an embodiment of the present disclosure.

### DETAILED DESCRIPTION

Features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “low” and “high,” or their respective comparative degrees (e.g., “lower” and “higher,” where applicable), when used with the compressor, turbine, shaft, or spool components, each refers to relative pressures or relative speeds, or both within an engine unless otherwise specified. For example, a “low-speed” component defines a component configured to operate at a rotational speed, such as a maximum allowable rotational speed, which is lower than that of a “high-speed” component of the engine. Alternatively, unless otherwise specified, the aforementioned terms may be understood in their superlative degree. For example, a “low-pressure turbine” may refer to the lowest maximum pressure within a turbine section, and a “high-pressure turbine” may refer to the highest maximum pressure within the turbine section. The terms “low” or “high” in such aforementioned terms may additionally, or alternatively, be understood as relative to minimum allowable speeds or pressures, or minimum or maximum allowable speeds or pressures relative to normal, desired, steady state, etc., operation of the engine, or any combination thereof.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the term “axial” refers to directions and orientations that extend substantially parallel to a longitudinal centerline axis of the turbine engine. Moreover, the terms “radial” and “radially” refer to directions and orientations that extend substantially perpendicular to the longitudinal centerline axis of the turbine engine. In addition, as used herein, the term “circumferentially” refers to directions and orientations that extend arcuately about the longitudinal centerline axis of the turbine engine.

An embodiment of the present disclosure provides variable pitch composite vanes, also referred to variable stator vanes (VSVs), in a turbine engine. With the increased use of variable stator vanes (e.g., VSVs), weight opportunities exist for composite use. VSVs are typically supported at the inner diameter (ID) and the outer diameter (OD) of the vanes. A VSV is configured to rotate around a longitudinal axis of the VSV to direct airflow. To maximize weight savings, the VSV should be made with as much composite material as possible. The VSV is generally provided with a shaft (also referred to as a trunnion, a spar, or a spindle) defining the longitudinal axis of the VSV and an airfoil portion connected to the shaft. In addition to using a composite material for the airfoil portion of the VSV, the shaft is also made of a composite material to further reduce the weight. For example, the shaft can be a perfect candidate for using a braided composite architecture where longitudinal fibers add stiffness and off-angle fibers add torsional rigidity. The airfoil portion of the VSV is then formed by wrapping a composite material around the composite shaft. Metal components may be incorporated at the ends of the shaft to add rigidity and to provide wear resistance.

In another embodiment, the shaft may be eliminated and, instead, ends having a metallic end portion and an intermediate portion can be used to support the composite airfoil that is mounted to the ends. The composite airfoil can be mounted to the ends to form the VSV. A lightweight foam insert can also be included inside the composite airfoil to further reduce weight.

In an embodiment, the intermediate portion is coupled to the metallic end portion. The intermediate portion can be made of a composite material or a metallic material. If the intermediate portion is made of a metallic material, the intermediate portion can be made integral as one unit with the metallic end portion. An interface of the intermediate portion with the composite airfoil can have various shapes including a scarf joint, a double scarf joint, a dove tail with tow wraps, etc. A non-composite material (e.g., a foam material) can be provided between the two intermediate ends.

The term “composite,” as used herein, is indicative of a component material having two or more constituent materials. A composite can be a combination of at least two or more metallic materials, non-metallic materials, or a combination of metallic and non-metallic elements or materials. Examples of a composite material can be, but not limited to, a polymer matrix composite (PMC), a ceramic matrix composite (CMC), a metal matrix composite (MMC). The composite may be formed of a matrix material and a reinforcing element, such as a fiber (referred to herein as a reinforcing fiber).

As used herein, “reinforcing fibers” may include, for example, glass fibers, carbon fibers, steel fibers, or para-aramid fibers, such as Kevlar® available from DuPont of Wilmington, Delaware. The reinforcing fibers may be in the form of fiber tows that include a plurality of fibers that are formed into a bundle. The polymeric matrix material may include, for example, thermoset resin, bismaleimide (BMI) materials, polyimide materials, or thermoplastic resin.

“Preform” as used herein is a piece of a braid, a two-dimensional woven layup, or a hybrid combination, or a three-dimensional composite woven fabric formed by a plurality of reinforcing fibers including warp fiber tows and weft fiber tows.

As used herein, a “composite component” refers to a structure or a component including any suitable composite material. Composite components, such as a composite airfoil (e.g., a composite fan blade or a composite variable stator vane or VSV), can include several layers or plies of composite material (composite plies). The layers or plies can vary in stiffness, material, and dimension to achieve the desired composite component or composite portion of a component having a predetermined weight, size, stiffness, and strength.

One or more layers of adhesive can be used in forming or coupling composite components. Adhesives can include resin and phenolics, wherein the adhesive can require curing at elevated temperatures or other curing techniques such as radiation curing.

As may be used herein, PMC refers to a class of materials. The PMC material may be a prepreg. A prepreg is a reinforcement material (e.g., a reinforcing fiber) pre-impregnated with a polymer matrix material, such as thermoplastic resin. Non-limiting examples of processes for producing thermoplastic prepregs include hot melt pre-pregging in which the fiber reinforcement material is drawn through a molten bath of resin and powder pre-pregging in which a resin is deposited onto the fiber reinforcement material, by way of a non-limiting example, electrostatically, and then adhered to the fiber, by way of a non-limiting example, in an oven or with the assistance of heated rollers.

Resins for matrix materials of PMCs can be generally classified as thermoset resin polymers or thermoplastic resin polymers. Thermoplastic resin polymers are generally categorized as polymers that can be repeatedly softened and caused to flow when heated, and hardened, when sufficiently cooled due to physical rather than chemical changes. Notable example classes of thermoplastic resin polymers include nylons, thermoplastic polyesters, polyaryletherketones, and polycarbonate resins. A specific example of high-performance thermoplastic resins that have been contemplated for use in aerospace applications include polyetheretherketone (PEEK), polyetherketoneketone (PEKK), polyetherimide (PEI), polyaryletherketone (PAEK), and polyphenylene sulfide (PPS). In contrast, once fully cured into a hard rigid solid, thermoset resins do not undergo significant softening when heated, but instead, thermally decompose when sufficiently heated. Notable examples of thermoset resin polymers include epoxy, bismaleimide (BMI), and polyimide resins.

Instead of using a prepreg with thermoplastic polymers, another non-limiting example utilizes a woven fabric. A woven fabric can include, but is not limited to, dry carbon fibers woven together with thermoplastic polymer fibers or filaments. Non-prepreg braided architectures can be made in a similar fashion. With this approach, it is possible to tailor the fiber volume of the part by dictating the relative concentrations of the thermoplastic fibers and reinforcement fibers that have been woven or braided together. Additionally, different types of reinforcement fibers can be braided or woven together in various concentrations to tailor the properties of the part. For example, glass fibers, carbon fibers, and thermoplastic fibers could all be woven together in various concentrations to tailor the properties of the part. Although the carbon fibers provide the strength of the system, the glass fibers can be incorporated to enhance the impact properties, which is a design characteristic for parts located near the inlet of the engine, and the thermoplastic fibers provide the binding for the reinforcement fibers.

In yet another non-limiting example, resin transfer molding (RTM) can be used to form at least a portion of a composite component. Generally, RTM includes the application of dry fibers to a mold or a cavity. The dry fibers can include prepreg, braided material, woven material, or any combination thereof. Resin can be pumped into or otherwise provided to the mold or the cavity to impregnate the dry fibers. The combination of the impregnated fibers and the resin is then cured and removed from the mold. When removed from the mold, the composite component can require post-curing processing. RTM may be a vacuum assisted process. That is, the air from the cavity or the mold can be removed and replaced by the resin prior to heating or curing. The placement of the dry fibers can be manual or automated. The dry fibers can be contoured to shape the composite component or to direct the resin. Optionally, additional layers or reinforcing layers of a material differing from the dry fiber can also be included or added prior to heating or curing.

As used herein, CMC refers to a class of materials with reinforcing fibers in a ceramic matrix. Generally, the reinforcing fibers provide structural integrity to the ceramic matrix. Some examples of reinforcing fibers can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Some examples of ceramic matrix materials can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) can also be included within the ceramic matrix.

Generally, particular CMCs can be referred to as their combination of type of fiber/type of matrix. For example, C/SiC for carbon-fiber-reinforced silicon carbide, SiC/SiC for silicon carbide-fiber-reinforced silicon carbide, SiC/SiN for silicon carbide fiber-reinforced silicon nitride, SiC/SiC-SiN for silicon carbide fiber-reinforced silicon carbide/silicon nitride matrix mixture, etc. In other examples, the CMCs can be comprised of a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃•2SiO₂), as well as glassy aluminosilicates.

In certain non-limiting examples, the reinforcing fibers may be bundled (e.g., form fiber tows) and/or coated prior to inclusion within the matrix. The bundles of fibers may be impregnated with a slurry composition prior to forming the preform or after formation of the preform. The preform may then undergo thermal processing, and subsequent chemical processing to arrive at a component formed of a CMC material having a desired chemical composition. For example, the preform may undergo a cure or a burn-out to yield a high char residue in the preform, and subsequent melt-infiltration with silicon, or a cure or a pyrolysis to yield a silicon carbide matrix in the preform, and subsequent chemical vapor infiltration with silicon carbide. Additional steps may be taken to improve densification of the preform, either before or after chemical vapor infiltration, by injecting the preform with a liquid resin or a polymer followed by a thermal processing step to fill the voids with the silicon carbide. A CMC material as used herein may be formed using any known or hereafter developed methods including, but not limited to, melt infiltration, chemical vapor infiltration, polymer impregnation pyrolysis (PIP), or any combination thereof.

The term “metallic” as used herein is indicative of a material that includes metal such as, but not limited to, titanium, iron, aluminum, stainless steel, and nickel alloys. A metallic material or an alloy can be a combination of at least two or more elements or materials, where at least one is a metal.

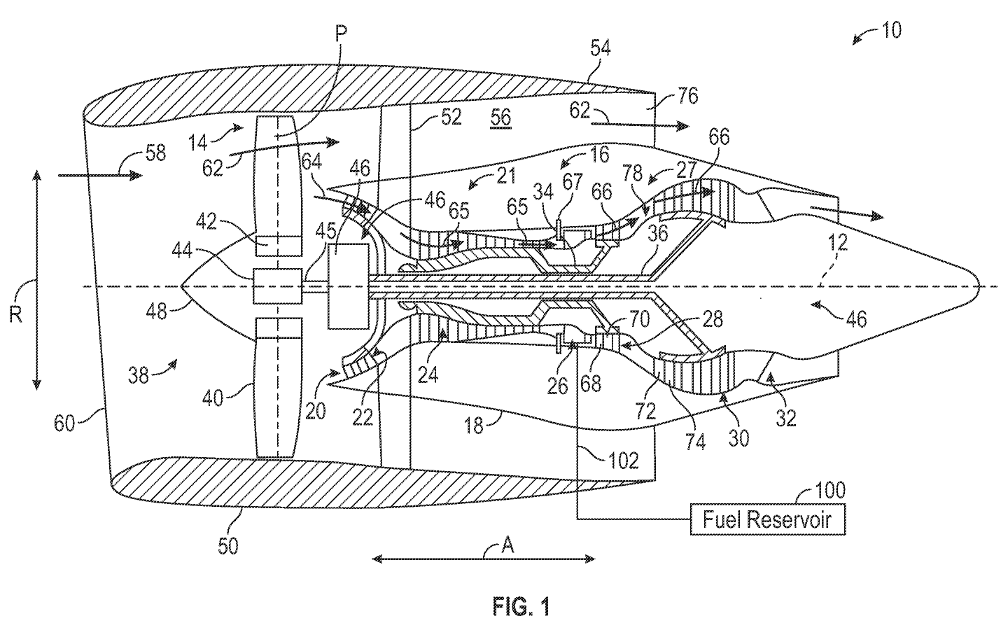

Referring now to the drawings, FIG. 1 is a schematic, cross-sectional view of a turbine engine 10, taken along a longitudinal centerline axis 12 of the turbine engine 10, according to an embodiment of the present disclosure. As shown in FIG. 1, the turbine engine 10 defines an axial direction A (extending parallel to the longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 depicted in FIG. 1 generally includes an outer casing 18 that is substantially tubular and defines an annular inlet 20. As schematically shown in FIG. 1, the outer casing 18 encases, in serial flow relationship, a compressor section 21 including a booster or a low-pressure (LP) compressor 22 followed downstream by a high-pressure (HP) compressor 24, a combustion section 26, a turbine section 27 including a high-pressure (HP) turbine 28 followed downstream by a low-pressure (LP) turbine 30, and a jet exhaust nozzle section 32. A high-pressure (HP) shaft 34 or a spool drivingly connects the HP turbine 28 to the HP compressor 24, to rotate the HP turbine 28 and the HP compressor 24 in unison. A low-pressure (LP) shaft 36 or a spool drivingly connects the LP turbine 30 to the LP compressor 22, to rotate the LP turbine 30 and the LP compressor 22 in unison. The compressor section 21, the combustion section 26, the turbine section 27, and the jet exhaust nozzle section 32 together define a core air flowpath.

For the embodiment depicted in FIG. 1, the fan section 14 includes a fan 38 (e.g., a variable pitch fan) having a plurality of fan blades 40 (airfoils) coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 or at least a portion of the turbo-engine 16, or both. The nacelle 50 is supported relative to the turbo-engine 16 by a plurality of circumferentially spaced outlet guide vanes 52 (e.g., VSVs). Moreover, a downstream section 54 of the nacelle 50 extends over an outer portion of the turbo-engine 16 to define a bypass airflow passage 56 therebetween.

During operation of the turbine engine 10, a volume of air 58 enters the turbine engine 10 through an inlet 60 of the nacelle 50 or the fan section 14, or both. As the volume of air 58 passes across the fan blades 40 (rotating airfoils), a first portion of air 62 is directed or routed into the bypass airflow passage 56, and a second portion of air 64 is directed or is routed into the upstream section of the core air flowpath, or, more specifically, into the annular inlet 20 of the LP compressor 22. The ratio between the first portion of air 62 and the second portion of air 64 is commonly known as a bypass ratio. The pressure of the second portion of air 64 is then increased, forming compressed air 65, and the compressed air 65 is routed through the HP compressor 24 and into the combustion section 26, where the compressed air 65 is mixed with fuel and burned to generate combustion gases 66. The fuel can be a hydrogen fuel. The fuel can be transported from a fuel reservoir 100 using a fuel pipe 102 to the combustion section 26.

The combustion gases 66 are routed into the HP turbine 28 and expanded through the HP turbine 28 where a portion of thermal energy or kinetic energy, or both, from the combustion gases 66 is extracted via sequential stages of HP turbine stator vanes 68 (e.g., VSVs) that are coupled to the outer casing 18 and HP turbine rotor blades 70 (rotating airfoils) that are coupled to the HP shaft 34, thus, causing the HP shaft 34 to rotate, thereby supporting operation of the HP compressor 24. The combustion gases 66 are then routed into the LP turbine 30 and expanded through the LP turbine 30. Here, a second portion of the thermal energy and the kinetic energy is extracted from the combustion gases 66 via sequential stages of LP turbine stator vanes 72 (e.g., VSVs) that are coupled to the outer casing 18 and LP turbine rotor blades 74 (rotating airfoils) that are coupled to the LP shaft 36, thus, causing the LP shaft 36 to rotate, thereby supporting operation of the LP compressor 22 and rotation of the fan 38 via the gearbox assembly 46. The term “stator” in “stator vanes” is used herein to mean that the vanes are not rotatable around the longitudinal centerline axis 12 of the turbine engine 10. However, the “stator vanes” can be variable stator vanes (VSVs) in the sense that each vane may be rotatable around the longitudinal axis of the vane to direct airflow.

The combustion gases 66 are subsequently routed through the jet exhaust nozzle section 32 of the turbo-engine 16 to provide propulsive thrust. Simultaneously, the pressure of the first portion of air 62 is substantially increased as the first portion of air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

The turbine engine 10 depicted in FIG. 1 is by way of example only. In other embodiments, the turbine engine 10 may have any other suitable configuration. For example, in other embodiments, the fan 38 may be configured in any other suitable manner (e.g., as a fixed pitch fan) and further may be supported using any other suitable fan frame configuration. Moreover, in other embodiments, any other suitable number or configuration of compressors, turbines, shafts, or a combination thereof may be provided. In still other embodiments, aspects of the present disclosure may be incorporated into any other suitable turbine engine, such as, for example, turbofan engines, propfan engines, turbojet engines, turboprop, or turboshaft engines.

The turbine engine 10 discussed herein is suitable for use on aircraft. Suitable aircraft include, for example, airplanes and unmanned aerial vehicles (UAV). In other embodiments, the turbine engine can be any other turbine engine, such as an industrial turbine engine incorporated into a power generation system, or a nautical turbine engine on a ship or other vessel.

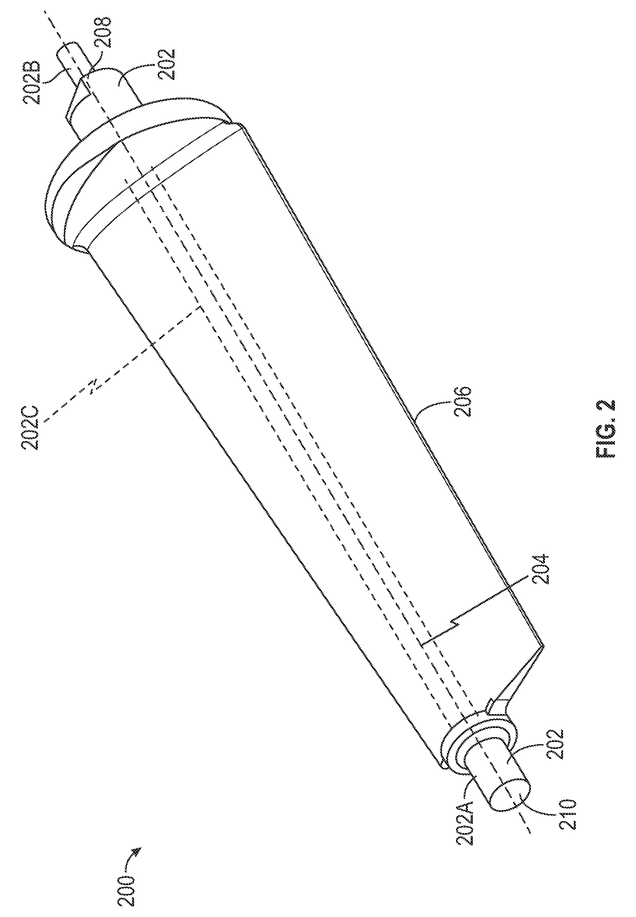

FIG. 2 is a schematic, perspective view of a variable stator vane (VSV) 200, according to an embodiment of the present disclosure. The VSV 200 includes a shaft 202 (also referred to as a trunnion, a spar, or a spindle) defining the longitudinal axis 204 of the VSV 200. The VSV 200 also includes an airfoil portion 206 coupled to a shaft portion 202C. The airfoil portion 206 and the shaft 202 are rotatable around the longitudinal axis 204 of the VSV 200 to direct airflow.

In an embodiment, the VSV 200 is supported at an inner diameter (ID) 208 and an outer diameter (OD) 210 of the VSV 200. The VSV 200 is configured to rotate around the longitudinal axis 204 of the VSV 200 to direct airflow.

In an embodiment, the shaft 202 includes a first metallic end 202A and a second metallic end 202B, and a shaft portion 202C between the first metallic end 202A and the second metallic end 202B. The shaft portion 202C is made of a first composite material. The shaft portion 202C is coupled to the first metallic end 202A and the second metallic end 202B. In an embodiment, the shaft 202 includes the first metallic end 202A at the OD 210 and the second metallic end 202B at the ID 208, to add rigidity to the VSV 200 and to provide wear resistance. In an embodiment, the first metallic end 202A of the shaft 202 and the second metallic end 202B of the shaft 202 are less than or equal to twenty-five percent of a total span of the shaft 202 or a total span of the VSV 200. Therefore, seventy-five percent or more of the total span of the shaft 202 is occupied by the shaft portion 202C.

In an embodiment, the airfoil portion 206 is made of a composite material to reduce weight of the VSV 200. In addition, the shaft portion 202C is also made of a composite material to further reduce weight of the VSV 200. In an embodiment, the shaft portion 202C is made of the first composite material and the airfoil portion 206 of the VSV 200 can be formed by wrapping the second composite material around the shaft portion 202C.

In an embodiment, the first composite material of the shaft portion 202C is the same as the second composite material of the airfoil portion 206 of the VSV 200. In another embodiment, the first composite material of the shaft portion 202C is different from the second composite material of the airfoil portion 206 of the VSV 200.

In an embodiment, the shaft portion 202C may have a first composite material architecture and the airfoil portion 206 may have a second composite material architecture. The first composite material of the shaft portion 202C has the first composite material architecture and the second material of the airfoil portion 206 has the second composite material architecture. In an embodiment the first composite material architecture of the shaft portion 202C can be the same as the second composite material architecture of the airfoil portion 206. In another embodiment, the first composite material architecture of the shaft portion 202C is different from the second composite material architecture of the airfoil portion 206. For example, the first composite material architecture of the shaft portion 202C may be a laminate composite material architecture, while the second composite material architecture of the airfoil portion 206 may be a braided composite material architecture, or vice versa.

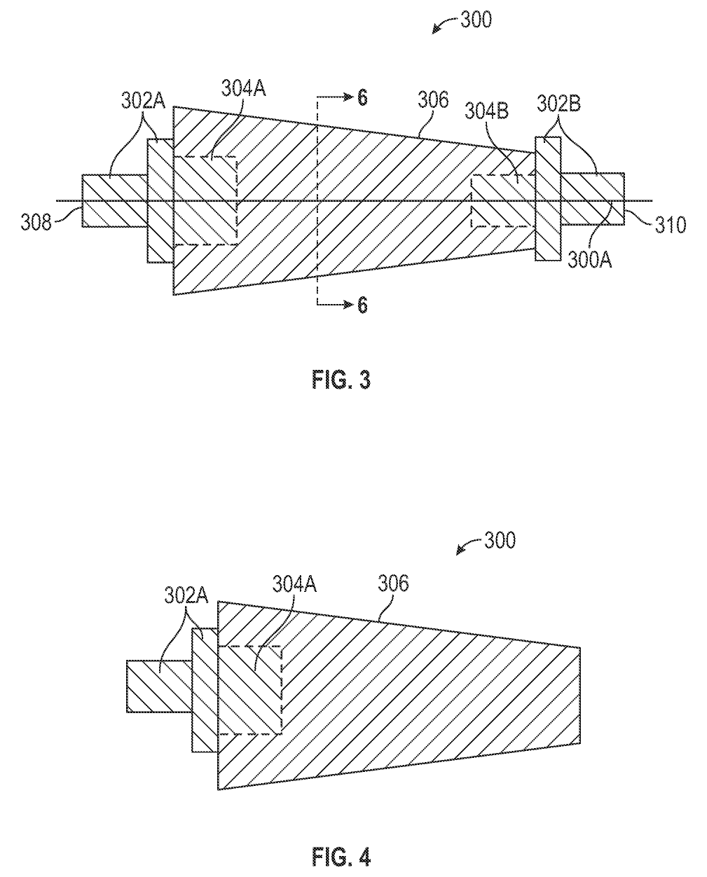

FIG. 3 is a schematic, cross-sectional view of a VSV 300, according to another embodiment of the present disclosure. The VSV 300 includes a first metallic end 302A and a second metallic end 302B spaced apart from the first end to define a longitudinal axis 300A of the VSV 300. In this embodiment, the VSV 300 does not include a shaft. Instead, the VSV 300 includes a first intermediate portion 304A and a second intermediate portion 304B that are opposite to each other, spaced apart from each other, and aligned along the longitudinal axis 300A. The first intermediate portion 304A is coupled to the first metallic end 302A and the second intermediate portion 304B is coupled the second metallic end 302B.

In an embodiment, the first metallic end 302A and the second metallic end 302B are made of a metallic material to add rigidity to the VSV 300 and to provide wear resistance. In an embodiment, the first intermediate portion 304A and the second intermediate portion 304B can be made from a metallic material or from a composite material. For example, the first intermediate portion 304A and the second intermediate portion 304B can be made from the same metallic material as the first metallic end 302A and the second metallic end 302B. For example, the first metallic end 302A and the first intermediate portion 304A can be integrally formed as one unit from the same metallic material. Similarly, the second metallic end 302B and the second intermediate portion 304B can also be integrally formed as one unit from the same metallic material.

In an embodiment, the first intermediate portion 304A and the second intermediate portion 304B can be made from a composite material. In this case, the composite material of the first intermediate portion 304A can be adhesively coupled to the metallic material of the first metallic end 302A and the composite material of the second intermediate portion 304B can be adhesively coupled to the metallic material of the second metallic end 302B.

The VSV 300 further includes an airfoil portion 306 that is coupled to the first intermediate portion 304A and to the second intermediate portion 304B. The airfoil portion 306, the first intermediate portion 304A, the second intermediate portion 304B, the first metallic end 302A, and the second metallic end 302B are rotatable around the longitudinal axis 300A of the VSV 300 to direct airflow.

In an embodiment, the VSV 300 is supported at an inner diameter (ID) 308 and an outer diameter (OD) 310 of the VSV 300.

In an embodiment, the airfoil portion 306 of the VSV 200 can be formed by wrapping the composite material of the airfoil portion 306 around the first intermediate portion 304A and the second intermediate portion 304B. In another embodiment, the composite material of the airfoil portion 306 can be adhesively coupled to the first intermediate portion 304A and to the second intermediate portion 304B.

In an embodiment, the composite material of the airfoil portion 306 can be the same as the composite material of the first intermediate portion 304A and the second intermediate portion 304B. In another embodiment, the composite material of the airfoil portion 306 can be different from the composite material of first intermediate portion 304A and the second intermediate portion 304B.

In an embodiment, the first intermediate portion 304A and the second intermediate portion 304B may have a first composite material architecture and the airfoil portion 306 may have a second composite material architecture. For example, the first composite material architecture of the first intermediate portion 304A and the second intermediate portion 304B may be a laminate composite material architecture, while the second composite material architecture of the airfoil portion 306 may be a braided composite material architecture, or vice versa.

In FIG. 3, the VSV 300 is shown having the first metallic end 302A and the second metallic end 302B, to support the VSV 300 at the inner diameter (ID) 308 and the outer diameter (OD) 310 of the VSV 300. The VSV 300 can also be provided with only one end, the first metallic end 302A or the second metallic end 302B, to be supported at the inner diameter (ID) 308 or the outer diameter (OD) 310.

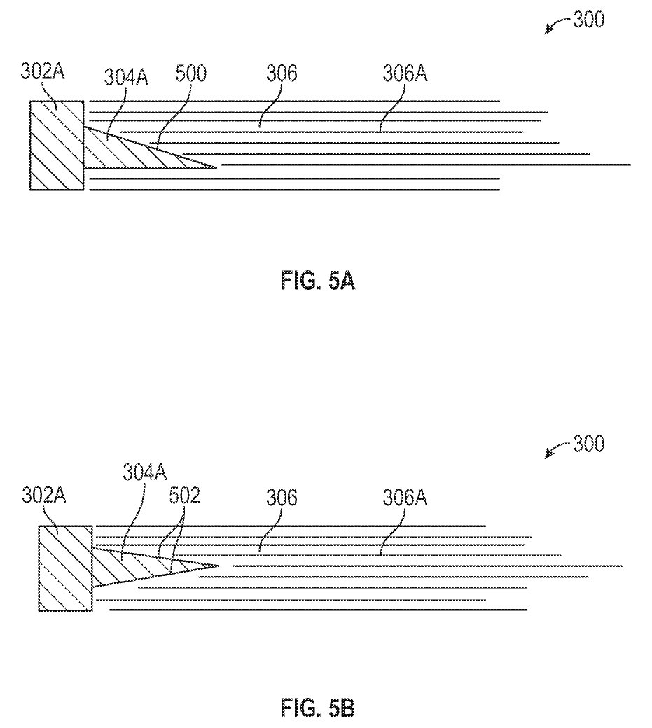

FIG. 4 is a schematic, cross-sectional view of the VSV 300 supported at one end, according to another embodiment of the present disclosure. As shown in FIG. 4, the VSV 300 has the first metallic end 302A to support the VSV 300 at the inner diameter (ID) 308. In this embodiment, the VSV 300 is not provided with the second metallic end 302B. In this embodiment, the airfoil portion 306 is free and not coupled to the second metallic end 302B.

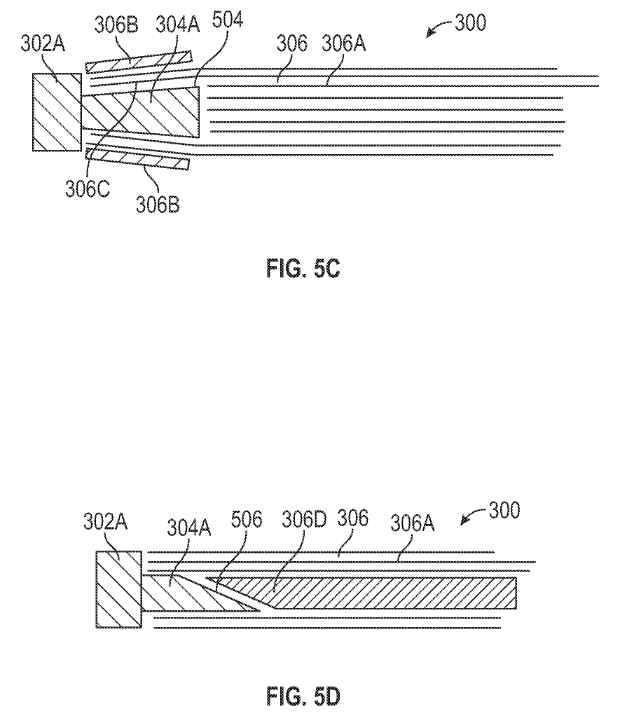

FIG. 5A is a schematic, cross-sectional view of a portion of the VSV 300 showing a scarf joint 500 between the first intermediate portion 304A and the airfoil portion 306, according to an embodiment of the present disclosure. In this embodiment, the first intermediate portion 304A has a triangular shape or a wedge shape, forming a scarf joint 500 between the first intermediate portion 304A and the airfoil portion 306. In this embodiment, plies or layers 306A of the composite material of the airfoil portion 306 are shown generally extending perpendicular to the first metallic end 302A.

FIG. 5B is a schematic, cross-sectional view of a portion of the VSV 300 showing a double scarf joint 502 between the first intermediate portion 304A and the airfoil portion 306, according to an embodiment of the present disclosure. In this embodiment, the first intermediate portion 304A has a triangular shape or a wedge shape, forming a double scarf joint 502 between the first intermediate portion 304A and the airfoil portion 306. In this embodiment, the layers 306A of the composite material of the airfoil portion 306 are shown generally extending perpendicular to the first metallic end 302A.

FIG. 5C is a schematic, cross-sectional view of a portion of the VSV 300 showing a dovetail joint 504 between the first intermediate portion 304A and the airfoil portion 306, according to an embodiment of the present disclosure. In this embodiment, the first intermediate portion 304A has a trapezoid shape forming the dovetail joint 504 between the first intermediate portion 304A and the airfoil portion 306. Tow wrap layers 306B (plies) of the composite material of the airfoil portion 306 are used wrap around the dovetail joint 504 at the first intermediate portion 304A to couple the layers 306A of the composite material of the airfoil portion 306 to the first intermediate portion 304A. In this embodiment, the layers 306A of the composite material of the airfoil portion 306 are shown generally extending perpendicular to the first metallic end 302A. Peripheral layers 306C of the composite material of the airfoil portion 306 are bent around the first intermediate portion 304A and the tow wrap layers 306B of the composite material of the airfoil portion 306 are used to wrap around the peripheral layers 306C and the first intermediate portion 304A, to couple the composite material of the airfoil portion 306 to the first intermediate portion 304A.

Although FIGS. 5A through 5C depict the joint between the first intermediate portion 304A and the airfoil portion 306, the description above is also applicable to the joint between the second intermediate portion 304B and the airfoil portion 306.

FIG. 5D is a schematic, cross-sectional view of a portion of the VSV 300 showing a non-composite material (e.g., foam material) insert 306D incorporated within the layers 306A of the composite material of the airfoil portion 306, according to an embodiment of the present disclosure. In this embodiment, the non-composite material insert 306D is provided (e.g., inserted) between the layers 306A of the composite material of the airfoil portion 306. The non-composite material insert 306D can be used to further decrease the overall weight of the VSV 300. The non-composite material 306D has a density less than or equal to a density of the composite material of the airfoil portion. In this embodiment, a wedge-type joint between the first intermediate portion 304 and the airfoil portion 306 can be used. The wedge-type joint can be similar to the scarf joint 500 shown in FIG. 5A.

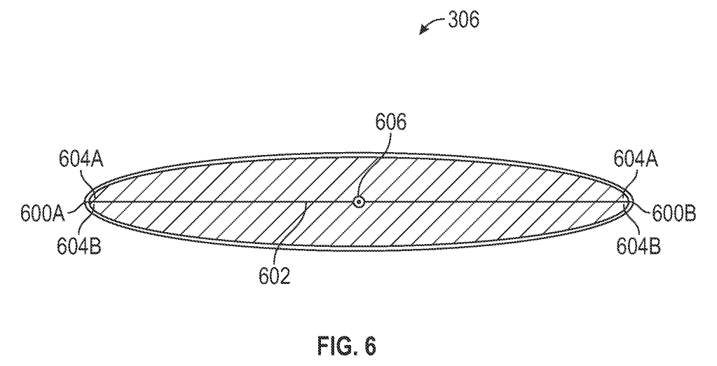

FIG. 6 is a schematic, transverse, cross-sectional view of the airfoil portion 306 taken at line 6-6 shown in FIG. 3, according to an embodiment of the present disclosure. The transverse cross section of the airfoil portion 306 of the airfoil portion 306 is shown as schematically having an oval shape or an elliptical shape. The transverse cross section of the airfoil portion 306 can also have other shapes. The transverse cross section of the airfoil portion 306 has a first vertex 600A and second vertex 600B. A chord 602 of the airfoil portion 306 is defined as an imaginary straight line between the first vertex 600A and the second vertex 600B. A chord length refers to a distance between the first vertex 600A and the second vertex 600B.

In an embodiment, the composite material of the airfoil portion 306 includes a plurality of superposed layers within a polymer matrix. At the first vertex 600A and at the second vertex 600B along the chord 602 of the airfoil portion 306, a first superposed layer 604A, in the plurality of superposed layers of the composite material of the airfoil portion 306, is oriented at about zero degree and a second superposed layer 604B in the plurality of superposed layers of the composite material of the airfoil portion 306 is oriented at about ninety degrees. At the first vertex 600A and at the second vertex 600B, the first superposed layer 604A of the composite material of the airfoil portion 306 and the second superposed layer 604B of the composite material of the airfoil portion 306 form an angle of about ninety degrees relative to each other. At the mid-chord 606, the first superposed layer 604A of the composite material of the airfoil portion 306 is oriented at about -45 degrees and the second superposed layer 604B of the composite material of the airfoil portion 306 is oriented at about +45 degrees. The mid-chord 606 corresponds to mid-point along the chord 602 that divides the length of the chord 602 into two equidistant segments. Orienting the first superposed layer 604A and the second superposed layer 604B at, respectively, about -45 degrees and about +45 degrees, provides additional tortional stiffness or higher torsional stiffness of the airfoil portion. “Higher torsional stiffness” is used herein to mean less tortional deflection and less operating loss to provide harmonic vibration dampening.

Further aspects are provided by the subject matter of the following clauses.

A variable stator vane comprises a metallic end defining a longitudinal axis of the variable stator vane, the metallic end being configured to add rigidity and to provide wear resistance to the variable stator vane, an intermediate portion coupled to the metallic end, and an airfoil portion coupled to the intermediate portion, the airfoil portion being made of a composite material, the metallic end, the intermediate portion, and the airfoil portion being rotatable around the longitudinal axis of the variable stator vane.

The variable stator vane of the preceding clause, the metallic end is a first metallic end and the intermediate portion is a first intermediate portion, and further including a second metallic end spaced apart from the first metallic end and a second intermediate portion coupled to the second metallic end.

The variable stator vane of any preceding clause, the composite material of the airfoil portion being adhesively coupled to the first intermediate portion and to the second intermediate portion.

The variable stator vane of any preceding clause, the first intermediate portion or the second intermediate portion, or both, having a triangular shape or a wedge shape, forming a scarf joint between the first intermediate portion or the second intermediate portion and the airfoil portion.

The variable stator vane of any preceding clause, the first intermediate portion or the second intermediate portion, or both, having a triangular shape or a wedge shape, forming a double scarf joint between the first intermediate portion or the second intermediate portion and the airfoil portion.

The variable stator vane of any preceding clause, the airfoil portion including a non-composite material, the non-composite material having a density less than or equal to a density of the composite material of the airfoil portion.

The variable stator vane of any preceding clause, the non-composite material being incorporated within layers of the composite material of the airfoil portion to further decrease the overall weight of the variable stator vane.

The variable stator vane of any preceding clause, the composite material comprising a plurality of superposed layers, a first superposed layer in the plurality of superposed layers of the composite material of the airfoil portion is oriented at about -45 degrees and a second superposed layer in the plurality of superposed layers of the composite material of the airfoil portion is oriented at about +45 degrees at about a mid-point along a chord of the airfoil portion to provide additional tortional stiffness to the airfoil portion.

The variable stator vane of any preceding clause, the first intermediate portion and the second intermediate portion being made of a metallic material.

The variable stator vane of any preceding clause, the first intermediate portion or the second intermediate portion, or both, having a trapezoid shape, forming a dovetail joint between the first intermediate portion or the second intermediate portion and the airfoil portion.

The variable stator vane of any preceding clause, the composite material of the airfoil portion comprising a plurality of tow wrap layers that wrap around the dovetail joint at the first intermediate portion or the second intermediate portion, or both, to couple layers of the composite material of the airfoil portion to the first intermediate portion or the second intermediate portion, or both.

The variable stator vane of any preceding clause, the composite material comprising a plurality of superposed layers, a first superposed layer in the plurality of superposed layers of the composite material of the airfoil portion is oriented at about zero degree and a second superposed layer in the plurality of superposed layers of the composite material of the airfoil portion is oriented at about ninety degrees.

The variable stator vane of any preceding clause, the first superposed layer oriented at about zero degree and the second superposed layer oriented at ninety degrees being at a first vertex and a second vertex of a chord of the airfoil portion.

The variable stator vane of any preceding clause, the first metallic end being located at an outer diameter of the variable stator vane, and the second metallic end is located at an inner diameter of the variable stator vane.

The variable stator vane of any preceding clause, the first intermediate portion and the first metallic end being integrally formed as one unit from a same metallic material, and the second intermediate portion and the second metallic end are integrally formed as one unit from the same metallic material.

The variable stator vane of any preceding clause, the first intermediate portion and the second intermediate portion being made of a composite material.

The variable stator vane of any preceding clause, the composite material of the first intermediate portion being adhesively coupled to the first metallic end and the composite material of the second intermediate portion is adhesively coupled to the second metallic end.

The variable stator vane of any preceding clause, the composite material of the airfoil portion being the same composite material of the first intermediate portion and the second intermediate portion.

The variable stator vane of any preceding clause, the first intermediate portion and the second intermediate portion having a first composite material architecture and the airfoil portion has a second composite material architecture.

The variable stator vane of any preceding clause, the first composite material architecture of the first intermediate portion and the second intermediate portion being a laminate composite material architecture, and the second composite material architecture of the airfoil portion being a braided composite material architecture.

The variable stator vane of any preceding clause, the first composite material architecture of the first intermediate portion and the second intermediate portion being a braided composite material architecture, and the second composite material architecture of the airfoil portion being a laminate composite material architecture.

The variable stator vane of any preceding clause, further comprising a composite shaft portion, the airfoil portion being coupled to the composite shaft portion, and the metallic end being coupled to an end of the composite shaft portion.

The variable stator vane of any preceding clause, a composite material of the composite shaft portion being different from the composite material of the airfoil portion.

The variable stator vane of any preceding clause, a first composite material architecture of the composite shaft portion being different from a second composite material architecture of the airfoil portion.

A turbine engine comprising a plurality of variable stator vanes, each variable stator vane comprising a metallic end defining a longitudinal axis of the variable stator vane, the metallic end being configured to add rigidity and to provide wear resistance to the variable stator vane, an intermediate portion coupled to the metallic end, and an airfoil portion coupled to the intermediate portion, the airfoil portion being made of a composite material, the metallic end, the intermediate portion, and the airfoil portion being rotatable around the longitudinal axis of the variable stator vane.

The turbine engine of the preceding clause, wherein the metallic end is a first metallic end and the intermediate portion is a first intermediate portion, and each variable stator vane further includes a second metallic end spaced apart from the first metallic end and a second intermediate portion coupled to the second metallic end.

The turbine engine of any preceding clause, the composite material of the airfoil portion being adhesively coupled to the first intermediate portion and to the second intermediate portion.

The turbine engine of any preceding clause, the first intermediate portion or the second intermediate portion, or both, having a triangular shape or a wedge shape, forming a scarf joint between the first intermediate portion or the second intermediate portion and the airfoil portion.

The turbine engine of any preceding clause, the first intermediate portion or the second intermediate portion, or both, having a triangular shape or a wedge shape, forming a double scarf joint between the first intermediate portion or the second intermediate portion and the airfoil portion.

The turbine engine of any preceding clause, the airfoil portion including a non-composite material, the non-composite material having a density less than or equal to a density of the composite material of the airfoil portion.

The turbine engine of any preceding clause, the non-composite material being incorporated within layers of the composite material of the airfoil portion to further decrease the overall weight of the variable stator vane.

The turbine engine of any preceding clause, the composite material comprising a plurality of superposed layers, a first superposed layer in the plurality of superposed layers of the composite material of the airfoil portion is oriented at about -45 degrees and a second superposed layer in the plurality of superposed layers of the composite material of the airfoil portion is oriented at about +45 degrees at about a mid-point along a chord of the airfoil portion to provide additional tortional stiffness to the airfoil portion.

The turbine engine of any preceding clause, the first intermediate portion and the second intermediate portion being made of a metallic material.

The turbine engine of any preceding clause, the first intermediate portion or the second intermediate portion, or both, having a trapezoid shape, forming a dovetail joint between the first intermediate portion or the second intermediate portion and the airfoil portion.

The turbine engine of any preceding clause, the composite material of the airfoil portion comprising a plurality of tow wrap layers that wrap around the dovetail joint at the first intermediate portion or the second intermediate portion, or both, to couple layers of the composite material of the airfoil portion to the first intermediate portion or the second intermediate portion, or both.

The turbine engine of any preceding clause, the composite material comprising a plurality of superposed layers, a first superposed layer in the plurality of superposed layers of the composite material of the airfoil portion is oriented at about zero degree and a second superposed layer in the plurality of superposed layers of the composite material of the airfoil portion is oriented at about ninety degrees.

The turbine engine of any preceding clause, the first superposed layer oriented at about zero degree and the second superposed layer oriented at ninety degrees being at a first vertex and a second vertex of a chord of the airfoil portion.

The turbine engine of any preceding clause, the first metallic end being located at an outer diameter of the variable stator vane, and the second metallic end is located at an inner diameter of the variable stator vane.

The turbine engine of any preceding clause, the first intermediate portion and the first metallic end being integrally formed as one unit from a same metallic material, and the second intermediate portion and the second metallic end are integrally formed as one unit from the same metallic material.

The turbine engine of any preceding clause, the first intermediate portion and the second intermediate portion being made of a composite material.

The turbine engine of any preceding clause, the composite material of the first intermediate portion being adhesively coupled to the first metallic end and the composite material of the second intermediate portion is adhesively coupled to the second metallic end.

The turbine engine of any preceding clause, the composite material of the airfoil portion being the same composite material of the first intermediate portion and the second intermediate portion.

The turbine engine of any preceding clause, the first intermediate portion and the second intermediate portion having a first composite material architecture and the airfoil portion has a second composite material architecture.

The turbine engine of any preceding clause, the first composite material architecture of the first intermediate portion and the second intermediate portion being a laminate composite material architecture, and the second composite material architecture of the airfoil portion being a braided composite material architecture.

The turbine engine of any preceding clause, the first composite material architecture of the first intermediate portion and the second intermediate portion being a braided composite material architecture, and the second composite material architecture of the airfoil portion being a laminate composite material architecture.

The turbine engine of any preceding clause, each variable stator vane further comprises a composite shaft portion, the airfoil portion being coupled to the composite shaft portion, and the metallic end being coupled to an end of the composite shaft portion.

The turbine engine of any preceding clause, a composite material of the composite shaft portion being different from the composite material of the airfoil portion.

The turbine engine of any preceding clause, a first composite material architecture of the composite shaft portion being different from a second composite material architecture of the airfoil portion.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A variable stator vane comprising:
a metallic end defining a longitudinal axis of the variable stator vane, the metallic end being configured to add rigidity and to provide wear resistance to the variable stator vane;
an intermediate portion coupled to the metallic end; and
an airfoil portion coupled to the intermediate portion, the airfoil portion being made of a composite material,
wherein the metallic end, the intermediate portion, and the airfoil portion are rotatable around the longitudinal axis of the variable stator vane.

2. The variable stator vane of claim 1, wherein the metallic end is a first metallic end and the intermediate portion is a first intermediate portion, and further comprising a second metallic end spaced apart from the first metallic end and a second intermediate portion coupled to the second metallic end.

3. The variable stator vane of claim 2, wherein the composite material of the airfoil portion is adhesively coupled to the first intermediate portion and to the second intermediate portion.

4. The variable stator vane of claim 2, wherein the first intermediate portion or the second intermediate portion, or both, have a triangular shape or a wedge shape, forming a scarf joint between the first intermediate portion or the second intermediate portion and the airfoil portion.

5. The variable stator vane of claim 2, wherein the first intermediate portion or the second intermediate portion, or both, has a triangular shape or a wedge shape, forming a double scarf joint between the first intermediate portion or the second intermediate portion and the airfoil portion.

6. The variable stator vane of claim 2, wherein the airfoil portion includes a non-composite material, the non-composite material having a density less than or equal to a density of the composite material of the airfoil portion.

7. The variable stator vane of claim 2, wherein the composite material comprises a plurality of superposed layers, a first superposed layer in the plurality of superposed layers of the composite material of the airfoil portion is oriented at about -45 degrees and a second superposed layer in the plurality of superposed layers of the composite material of the airfoil portion is oriented at about +45 degrees at about a mid-point along a chord of the airfoil portion to provide additional tortional stiffness to the airfoil portion.

8. The variable stator vane of claim 2, wherein the first intermediate portion and the second intermediate portion are made of a metallic material.

9. The variable stator vane of claim 2, wherein the first intermediate portion or the second intermediate portion, or both, have a trapezoid shape, forming a dovetail joint between the first intermediate portion or the second intermediate portion and the airfoil portion.

10. The variable stator vane of claim 9, wherein the composite material of the airfoil portion comprises a plurality of tow wrap layers that wrap around the dovetail joint at the first intermediate portion or the second intermediate portion, or both, to couple the composite material of the airfoil portion to the first intermediate portion or the second intermediate portion, or both.

11. The variable stator vane of claim 2, wherein the composite material comprises a plurality of superposed layers, a first superposed layer in the plurality of superposed layers of the composite material of the airfoil portion is oriented at about zero degree and a second superposed layer in the plurality of superposed layers of the composite material of the airfoil portion is oriented at about ninety degrees.

12. The variable stator vane of claim 11, wherein the first superposed layer oriented at about zero degree and the second superposed layer oriented at ninety degrees are at a first vertex and a second vertex of a chord of the airfoil portion.

13. The variable stator vane of claim 2, wherein the first intermediate portion and the first metallic end are integrally formed as one unit from a same metallic material, and the second intermediate portion and the second metallic end are integrally formed as one unit from the same metallic material.

14. The variable stator vane of claim 2, wherein the first intermediate portion and the second intermediate portion are made of a composite material.

15. The variable stator vane of claim 14, wherein the composite material of the first intermediate portion is adhesively coupled to the first metallic end and the composite material of the second intermediate portion is adhesively coupled to the second metallic end.

16. The variable stator vane of claim 14, wherein the composite material of the airfoil portion is the same composite material as the first intermediate portion and the second intermediate portion.

17. The variable stator vane of claim 14, wherein the first intermediate portion and the second intermediate portion have a first composite material architecture and the airfoil portion has a second composite material architecture.

18. The variable stator vane of claim 17, wherein the first composite material architecture of the first intermediate portion and the second intermediate portion is a laminate composite material architecture, and the second composite material architecture of the airfoil portion is a braided composite material architecture.

19. The variable stator vane of claim 17, wherein the first composite material architecture of the first intermediate portion and the second intermediate portion is a braided composite material architecture, and the second composite material architecture of the airfoil portion is a laminate composite material architecture.

20. A turbine engine comprising a plurality of variable stator vanes, each variable stator vane comprising:
a metallic end defining a longitudinal axis of the variable stator vane, the metallic end being configured to add rigidity and to provide wear resistance to the variable stator vane;
an intermediate portion coupled to the metallic end; and
an airfoil portion coupled to the intermediate portion, the airfoil portion being made of a composite material,
wherein the metallic end, the intermediate portion, and the airfoil portion are rotatable around the longitudinal axis of the variable stator vane.
